(19) United States
(12) Patent Application Publication
(10) Pub. No.: US 2025/0067130 A1
(43) Pub. Date: Feb. 27, 2025

(54) COMPRESSIBLE SLEEVES, MAGNETIC ASSEMBLIES, AND METHODS TO RESTRAIN A COMPONENT OF A DOWNHOLE TOOL

(71) Applicant: Halliburton Energy Services, Inc., Houston, TX (US)

(72) Inventors: Minh Dang NGUYEN, Houston, TX (US); Brian BREAUX, Houston, TX (US)

(73) Assignee: Halliburton Energy Services, Inc., Houston, TX (US)

(21) Appl. No.: 18/236,838

(22) Filed: Aug. 22, 2023

(51) Int. Cl. E21B 17/10; E21B 17/042; H01F 7/00

(52) U.S. Cl. CPC E21B 17/1007; E21B 17/042; H01F 7/00

(57) ABSTRACT

A compressible sleeve includes a first shoulder configured to press against an insert. The compressible sleeve also includes a second shoulder positioned along an opposite end of the first shoulder, and configured to receive a pin of a rotary connection of the magnetic assembly. The compressible sleeve further includes a plurality of slots extending along a curved surface.

### BACKGROUND

The present disclosure relates generally to compressible sleeves, magnetic assemblies, and methods to restrain a component of a downhole tool.

Magnetic assemblies of downhole measurement while drilling (MWD) and logging while drilling (LWD) tools are sometimes adversely affected by downhole vibration. Sometimes, magnetics of magnetic assemblies are partially or entirely filled with a magnetic material having a density that is much higher than other components of the MWD/LWD tools, which require a robust mounting scheme. However, some mounting schemes do not account for the density/weight of the magnetic material.

### BRIEF DESCRIPTION OF THE DRAWINGS

Illustrative embodiments of the present disclosure are described in detail below with reference to the attached drawing figures, which are incorporated by reference herein, and wherein:

FIG. 1 illustrates a diagrammatic view of an example LWD/MWD wellbore operating environment;

FIG. 2 is a cross-sectional view of a magnetic assembly that is deployable in the environment of FIG. 1;

FIG. 3A is a perspective view of a compressible sleeve similar to the compressible sleeve of FIG. 2;

FIG. 3B is a perspective view of another compressible sleeve similar to the compressible sleeve of FIG. 2;

FIG. 4A is a cross-sectional view of a magnetic assembly that is deployable in the environment of FIG. 1 before a compressible sleeve is inserted into the magnetic assembly;

FIG. 4B is a cross-sectional view of the magnetic assembly of FIG. 4A after the compressible sleeve is inserted into the magnetic assembly;

FIG. 4C is a cross-sectional view of the magnetic assembly of FIG. 4B after the compressible sleeve is restrained; and

FIG. 5 is a flowchart of a process to restrain a magnetic insert.

The illustrated figures are only exemplary and are not intended to assert or imply any limitation with regard to the environment, architecture, design, or process in which different embodiments may be implemented.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

The present disclosure relates to compressible sleeves, magnetic assemblies, and methods to restrain a component of a downhole tool (e.g., a magnetic assembly, a logging tool, or another type of downhole tool). A compressible sleeve has a shoulder (first shoulder) that is configured to press against an insert (e.g., magnetic insert) of the downhole tool, and another shoulder (second shoulder) that is positioned along an opposite end of the first shoulder, where the second shoulder is configured to receive a pin of a rotary connection of the downhole tool. In some embodiments, the compressible sleeve is configured to receive a preload force that is applied to the second shoulder, and axially apply a portion of the preload force to the magnetic insert to lock the magnetic insert, and to restrain the magnetic insert to a collar of the downhole tool.

The compressible sleeve also includes slots that extend along a curved surface of the compressible sleeve. In some embodiments, the slots are rectangular shaped, oval shaped, diamond shaped, or have irregular shapes. In some embodiments, the ends of the slots are wider or narrower than the center portion of the slots. In some embodiments, the slots extend inward from the curved surface towards a central axis of the compressible sleeve. In one or more of such embodiments, the slots are staggered from each other, or take on different shapes and dimensions. In some embodiments, the shapes and dimensions of the slots are configured to reduce the stiffness of the compressible sleeve, such as to a pre-determined stiffness. Similarly, in some embodiments, the shapes and dimensions of the slots are configured to reduce the rigidity of the compressible sleeve, such as to a predetermined rigidity. In one or more of such embodiments, the predetermined stiffness and rigidity of the compressible sleeve are based on the weight, density, dimensions, material properties, and/or other quantifiable measurements of the magnetic insert or another component of the compressible sleeve is configured to hold in position. In some embodiments, the shapes and dimensions of the slots are selected to permit a deflection of the compressible sleeve to control force applied to the magnetic insert (or another component) and to prevent overloading on the magnetic insert (or the other component). Similarly, the shapes and dimensions of the compressible sleeve, as well as other material properties of the compressible sleeve are also selected to control force applied to the magnetic insert (or another component) and to prevent overloading on the magnetic insert (or the other component).

In some embodiments, the compressible sleeve is a component of a magnetic assembly, which also includes the magnetic insert. The compressible sleeve also includes a rotary connection. In some embodiments, the magnetic assembly has a hollow interior that is configured to receive the magnetic insert and the compressible sleeve. In some embodiments, the magnetic assembly includes a collar (e.g., antenna collar) positioned in the hollow interior, and configured to receive the magnetic insert and the compressible sleeve. In one or more of such embodiments, the magnetic insert is first inserted into the collar, and the compressible sleeve is subsequently inserted into the collar, where the first shoulder of the compressible sleeve presses against the magnetic insert. The rotary connection (or a pin of the rotary connection) is subsequently inserted into the hollow interior until the rotary connection is pressed against the second shoulder of the compressible sleeve. A threshold amount of pressure/force is applied to the second shoulder of the compressible sleeve to restrict movement of the magnetic insert. In some embodiments, the pressure/force induces a deflection of the compressible sleeve to control the force applied to the magnetic insert to prevent overloading on the magnetic insert.

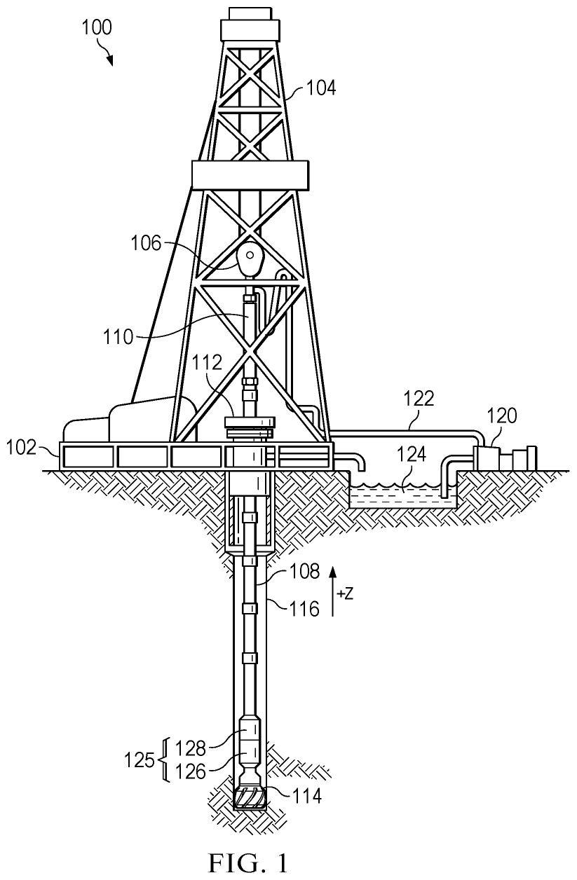

Similarly, the compressible sleeve is a component of non-magnetic assemblies and tools, including but not limited to, non-magnetic assemblies having similar components as the magnetic assemblies described herein, where the compressible sleeve is utilized to hold an insert (magnetic or non-magnetic) or another type of component in place. More particularly, the compressible sleeve is configurable to control the pressure/force applied to the component, and to prevent overloading on the component. Additional descriptions of compressible sleeves, magnetic assemblies, and methods to restrain a component of a downhole tool are provided in the paragraphs below and are illustrated in FIGS. 1-5.

Turning now to the figures, FIG. 1 illustrates a diagrammatic view of an exemplary LWD/MWD wellbore operating environment 100 in which the present disclosure may be implemented. As depicted in FIG. 1, a drilling platform 102 is equipped with a derrick 104 that supports a hoist 106 for raising and lowering a drill string 108. The hoist 106 suspends a top drive 110 suitable for rotating the drill string 108 and lowering the drill string 108 through the well head 112. Connected to the lower end of the drill string 108 is a drill bit 114. As the drill bit 114 rotates, the drill bit 114 creates a wellbore 116 that passes through various formations. A pump 120 circulates drilling fluid through a supply pipe 122 to top drive 110, down through the interior of drill string 108, through orifices in drill bit 114, back to the surface via the annulus around drill string 108, and into a retention pit 124. The drilling fluid transports cuttings from the wellbore 116 into retention pit 124 and aids in maintaining the integrity of the wellbore 116. Various materials can be used for drilling fluid, including oil-based fluids and water-based fluids.

As depicted in FIG. 1, LWD/MWD tools (collectively “logging tools”) 126 are integrated into the bottom-hole assembly 125 near the drill bit 114. As the drill bit 114 extends to the wellbore 116 through the various formations, logging tools 126 collect measurements relating to various formation properties as well as the orientation of the tool and various other drilling conditions.

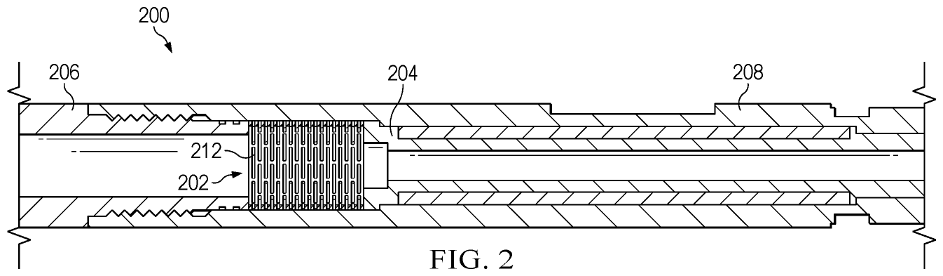

In the embodiment of FIG. 1, logging tools 126 includes a magnetic assembly 128 that is also integrated into the bottom-hole assembly 125. Magnetic assembly 128 includes a magnetic insert and a compressible sleeve configured to apply sufficient force to prevent undesirable movement of the magnetic insert without overloading the magnetic insert. More particularly, the compressible sleeve has a first shoulder configured to engage the magnetic insert, a second shoulder configured to engage a rotary connection, and lots extending along a curved surface of the compressible sleeve. Pressure/force applied by the rotary connection onto the second shoulder restricts movement of the magnetic insert. In some embodiments, the pressure/force also induces a deflection of the compressible sleeve to control the force applied to the magnetic insert to prevent overloading on the magnetic insert. Additional descriptions of similar magnetic assemblies and compressible sleeves are provided herein and are illustrated in at least FIGS. 2-4C.

FIG. 2 is a cross-sectional view of a magnetic assembly 200 that is deployable in the environment 100 of FIG. 1. In the embodiment of FIG. 2, magnetic assembly 200 includes a collar 208 that is fitted into an interior of magnetic assembly 200. Magnetic assembly 200 also includes a magnetic insert 204 that is at least partially fitted within collar 208. Magnetic assembly 200 also includes a compressible sleeve 202 that is pressed against magnetic insert 204 to prevent undesirable movement of magnetic insert 204. Magnetic assembly 200 also includes a rotary connection 206 that is pressed against insert 202. In the embodiment of FIG. 2, rotary connection 206 is pressed against a second shoulder of compressible sleeve 202 to hold and compress compressible sleeve 202. Compressible sleeve 202 includes multiple slots 212, which permit a certain degree of compression. Some of the pressure/force applied by rotary connection is transferred from a first shoulder of compressible sleeve 202 to magnetic insert 204. The material properties and size and dimensions of compressible sleeve 202, as well as the size and dimensions of slots 212 are selected to induce a deflection of compressible sleeve 202 to control the pressure/force applied to the magnetic insert 204 and to prevent overloading on magnetic insert 204.

Although FIG. 2 illustrates a magnetic assembly 200 having one magnetic insert 204 and one compressible sleeve 202, in some embodiments, a magnetic assembly includes a single compressible sleeve configured to restrict movement of multiple magnetic inserts positioned inside the compressible sleeve. Similarly, in some embodiments, a magnetic assembly includes multiple compressible sleeves configured to restrict movement of one or more magnetic inserts. Although FIG. 2 illustrates a magnetic assembly 200, it is understood that compressible sleeve 202 and other compressible sleeves described herein are configurable to be placed in other types of assemblies and apparatuses to prevent movement of a component (such as a magnetic insert, a non-magnetic insert, or another type of component), control the pressure/force applied to the component, and to prevent overloading on the component. For example, compressible sleeve 202 is configurable to be placed in another assembly/tool having a non-magnetic component to prevent undesirable movement of the non-magnetic component. Moreover, pressure/force applied to compressible sleeve 202 induces a deflection of compressible sleeve 202 to control the pressure/force applied to the non-magnetic component and to prevent overloading on the non-magnetic component.

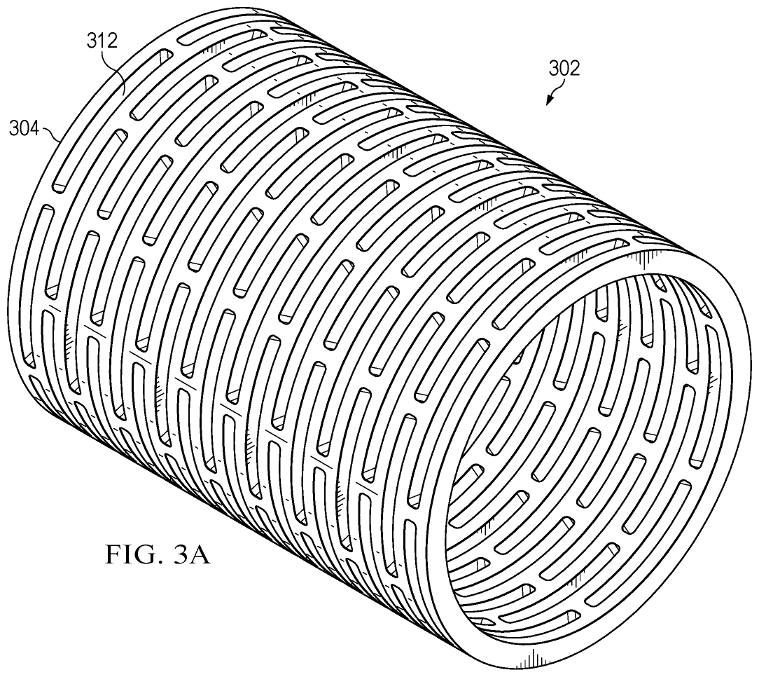

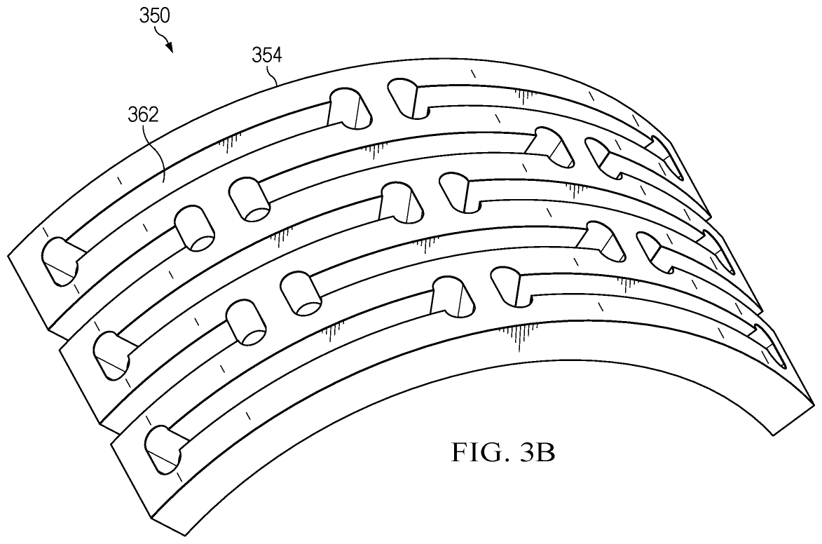

FIG. 3A is a perspective view of a compressible sleeve 302 similar to compressible sleeve 202 of FIG. 2. In the embodiment of FIG. 3A, compressible sleeve 302 includes multiple rectangular shaped slots 312 positioned along a curved surface 304 of compressible sleeve 302. Further in the embodiment of FIG. 3A, slots 312 extend from curved surface 304 inward towards a central axis (not shown) of compressible sleeve 302. FIG. 3B is a perspective view of another compressible sleeve 350 similar to compressible sleeve 202 of FIG. 2. In the embodiment of FIG. 3B, compressible sleeve 350 also includes multiple slots 362 positioned along a curved surface 354 of compressible sleeve 350. In the embodiment of FIG. 3B, slots 362 are wider along the ends than at the center.

FIGS. 3A and 3B illustrate two embodiments of compressible sleeves 302 and 350, respectively, having different shaped slots. In some embodiments, slots of the compressible sleeves have other types of shapes and dimensions that are configured to reduce the stiffness of the compressible sleeve, such as to a pre-determined stiffness. Similarly, in some embodiments, the shapes and dimensions of the slots are configured to reduce the rigidity of the compressible sleeve, such as to a predetermined rigidity. In one or more of such embodiments, the predetermined stiffness and rigidity of the compressible sleeve are based on the weight, density, dimensions, material properties, and/or other quantifiable measurements of the magnetic insert. In some embodiments, the shapes and dimensions of the slots are selected to permit a deflection of the compressible sleeve to control force applied to the magnetic insert and to prevent overloading on the magnetic insert. Similarly, the shapes and dimensions of the compressible sleeve, as well as other material properties of the compressible sleeve are also selected to control force applied to the magnetic insert and to prevent overloading on the magnetic insert.

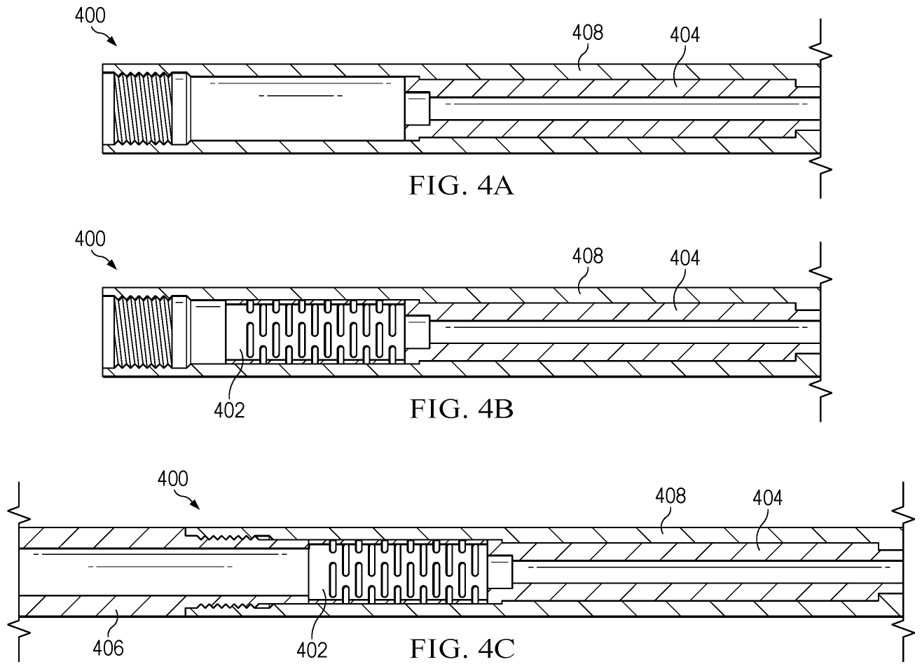

FIG. 4A is a cross-sectional view of a magnetic assembly 400 that is deployable in the environment of FIG. 1 before a compressible sleeve is inserted into magnetic assembly 400. In the embodiment of FIG. 4A, magnetic assembly 400 has a collar 408, and a magnetic insert 404 that has been inserted into collar 408. FIG. 4B is a cross-sectional view of magnetic assembly 400 of FIG. 4A after a compressible sleeve 402 is inserted into magnetic assembly 400. In the embodiment of FIG. 4B, a first shoulder of compressible sleeve 402 is pressed against magnetic insert 404. FIG. 4C is a cross-sectional view of magnetic assembly 400 of FIG. 4B after compressible sleeve 402 is restrained. In the embodiment of FIG. 4C, a rotary connection (or a pin of the rotary connection) 406 is pressed against a second shoulder of compressible sleeve 402. Pressure/force applied by rotary connection 406 onto the second shoulder of compressible sleeve 402 restricts movement of magnetic insert 404. In the embodiment of FIGS. 4A-4C, the pressure/force also induces a deflection of compressible sleeve 402 to control the force applied to magnetic insert 404 to prevent overloading on magnetic insert 404.

Although FIGS. 4A-4C illustrate a magnetic assembly 400, it is understood that compressible sleeve 402 and other compressible sleeves described herein are configurable to be placed in other types of assemblies and apparatuses to prevent movement of a component (such as a magnetic insert, a non-magnetic insert, or another type of component), control the pressure/force applied to the component, and to prevent overloading on the component. For example, compressible sleeve 402 is configurable to be placed in another assembly/tool having a non-magnetic component to prevent undesirable movement of the non-magnetic component. Moreover, pressure/force applied to compressible sleeve 402 induces a deflection of compressible sleeve 402 to control the pressure/force applied to the non-magnetic component and to prevent overloading on the non-magnetic component.

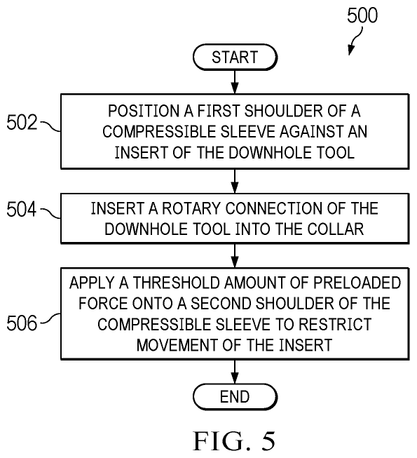

FIG. 5 is a flowchart of a process 500 to restrain a component of a downhole tool. Although the operations in process 500 are shown in a particular sequence, certain operations may be performed in different sequences or at the same time where feasible.

At block 502 a first shoulder of a compressible sleeve is positioned against a component of a downhole tool. In some embodiments, the component is a magnetic insert. In some embodiments, the component is a non-magnetic insert. FIG. 4B, for example, illustrates positioning a first shoulder of compressible sleeve 402 onto magnetic insert 404, both of which are inserted within a collar 408 of magnetic assembly 400. At block 504, a rotary connection of the downhole tool is inserted into a collar. In the embodiment of FIG. 4B, compressible sleeve 402 is inserted into collar 408, where the first shoulder of compressible sleeve abuts magnetic insert 404. At block 506, a threshold amount of preload force is applied onto a second shoulder of the compressible sleeve to restrict movement of the magnet insert. In the embodiment of FIG. 4C, a rotary connection 406 (or a pin of rotary connection 406) is pressed against the second shoulder of compressible sleeve 402. Pressure/force applied by rotary connection 406 is transferred from a first shoulder of compressible sleeve 402 to magnetic insert 404.

In some embodiments, pressure/force applied by the rotary connection induces a deflection of the compressible sleeve to control force applied to the component and to prevent overloading on the component. In one or more of such embodiments, the shapes and dimensions of the slots are selected to permit a deflection of the compressible sleeve to control force applied to the component and to prevent overloading on the component. Similarly, the shapes and dimensions of the compressible sleeve, as well as other material properties of the compressible sleeve are also selected to control force applied to the component and to prevent overloading on the component.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. For instance, although the flowcharts depict a serial process, some of the steps/processes may be performed in parallel or out of sequence, or combined into a single step/process. The scope of the claims is intended to broadly cover the disclosed embodiments and any such modification. Further, the following clauses represent additional embodiments of the disclosure and should be considered within the scope of the disclosure.

Clause 1, a compressible sleeve, comprising: a first shoulder configured to press against an insert of a downhole tool; a second shoulder positioned along an opposite end of the first shoulder, and configured to receive a pin of a rotary connection of the downhole tool; and a plurality of slots extending along a curved surface.

Clause 2, the compressible sleeve of clause 1, wherein the compressible sleeve is configured to: receive a preload force applied to the second shoulder; and axially apply a portion of the preload force to the insert to lock the insert to restrain the insert to a collar of the downhole tool.

Clause 3, the compressible sleeve of clause 2, wherein the compressible sleeve is configured to restrain the insert to the collar while the downhole tool experiences downhole vibrations.

Clause 4, the compressible sleeve of any of clauses 1-3, wherein the plurality of slots are configured to reduce a stiffness of the compressible sleeve.

Clause 5, the compressible sleeve of any of clauses 1-4, wherein the plurality of slots are configured to reduce a rigidity of the compressible sleeve.

Clause 6, the compressible sleeve of any of clauses 1-5, wherein the plurality of slots extend from the curved surface inward toward a central axis of the compressible sleeve.

Clause 7, the compressible sleeve of clause 6, wherein the plurality of slots are staggered from each other.

Clause 8, the compressible sleeve of any of clauses 1-7, wherein one or more of the plurality of slots are oval shaped.

Clause 9, the compressible sleeve of any of clauses 1-8, wherein one or more of the plurality of slots have ends that are wider than a center portion.

Clause 10, a magnetic assembly, comprising: a magnetic insert; a rotary connection; and a compressible sleeve comprising: a first shoulder configured to press against the magnetic insert; a second shoulder positioned along an opposite end of the first shoulder, and configured to receive a pin of the rotary connection; and a plurality of slots extending along a curved surface.

Clause 11, the magnetic assembly of clause 10, wherein the compressible sleeve is configured to: receive a preload force applied to the second shoulder; and axially apply a portion of the preload force to the insert to lock the insert to restrain the insert to a collar of the magnetic assembly.

Clause 12, the magnetic assembly of clause 11, wherein the compressible sleeve is configured to restrain the insert to the collar while the magnetic assembly experiences downhole vibrations.

Clause 13, the magnetic assembly of clauses 11 or 12, wherein the plurality of slots are configured to reduce a stiffness of the compressible sleeve.

Clause 14, the magnetic assembly of any of clauses 11-13, wherein the plurality of slots are configured to reduce a rigidity of the compressible sleeve.

Clause 15, the magnetic assembly of any of clauses 11-14, wherein the plurality of slots extend from the curved surface inward toward a central axis of the compressible sleeve.

Clause 16, the magnetic assembly of clause 15, wherein the plurality of slots are staggered from each other.

Clause 17, the magnetic assembly of any of clauses 11-16, wherein one or more of the plurality of slots are oval shaped.

Clause 18, the magnetic assembly of any of clauses 11-17, wherein one or more of the plurality of slots have ends that are wider than a center portion.

Clause 19, a method to restrain a magnetic insert of a downhole tool, comprising: positioning a first shoulder of a compressible sleeve against a magnetic insert of the downhole tool, wherein the compressible sleeve and the magnetic insert fit within an internal diameter of a collar of the downhole tool, the compressible sleeve comprising a plurality of slots extending along a curved surface of the compressible sleeve; inserting a rotary connection of the downhole tool into the collar; applying a threshold amount of preload force onto a second shoulder of the compressible sleeve to restrict movement of the magnetic insert.

Clause 20, the method of clause 19 further comprising inducing a deflection of the compressible sleeve to control force applied to the magnetic insert and to prevent overloading on the magnetic insert.

As used herein, the singular forms “a,” “an,” and “the” are intended to include the plural forms as well, unless the context clearly indicates otherwise. It will be further understood that the terms “comprise” and/or “comprising,” when used in this specification and/or in the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

1. A compressible sleeve, comprising:
a first shoulder configured to press against an insert of a downhole tool;
a second shoulder positioned along an opposite end of the first shoulder, and configured to receive a pin of a rotary connection of the downhole tool; and
a plurality of slots extending along a curved surface.

2. The compressible sleeve of claim 1, wherein the compressible sleeve is configured to:
receive a preload force applied to the second shoulder; and
axially apply a portion of the preload force to the insert to lock the insert to restrain the insert to a collar of the downhole tool.

3. The compressible sleeve of claim 2, wherein the compressible sleeve is configured to restrain the insert to the collar while the downhole tool experiences downhole vibrations.

4. The compressible sleeve of claim 1, wherein the plurality of slots are configured to reduce a stiffness of the compressible sleeve.

5. The compressible sleeve of claim 1, wherein the plurality of slots are configured to reduce a rigidity of the compressible sleeve.

6. The compressible sleeve of claim 1, wherein the plurality of slots extend from the curved surface inward toward a central axis of the compressible sleeve.

7. The compressible sleeve of claim 6, wherein the plurality of slots are staggered from each other.

8. The compressible sleeve of claim 1, wherein one or more of the plurality of slots are oval shaped.

9. The compressible sleeve of claim 1, wherein one or more of the plurality of slots have ends that are wider than a center portion.

10. A magnetic assembly, comprising:
a magnetic insert;
a rotary connection; and
a compressible sleeve comprising:
a first shoulder configured to press against the magnetic insert;
a second shoulder positioned along an opposite end of the first shoulder, and configured to receive a pin of the rotary connection; and
a plurality of slots extending along a curved surface.

11. The magnetic assembly of claim 10, wherein the compressible sleeve is configured to:
receive a preload force applied to the second shoulder; and
axially apply a portion of the preload force to the insert to lock the insert to restrain the insert to a collar of the magnetic assembly.

12. The magnetic assembly of claim 11, wherein the compressible sleeve is configured to restrain the insert to the collar while the magnetic assembly experiences downhole vibrations.

13. The magnetic assembly of claim 11, wherein the plurality of slots are configured to reduce a stiffness of the compressible sleeve.

14. The magnetic assembly of claim 11, wherein the plurality of slots are configured to reduce a rigidity of the compressible sleeve.

15. The magnetic assembly of claim 11, wherein the plurality of slots extend from the curved surface inward toward a central axis of the compressible sleeve.

16. The magnetic assembly of claim 15, wherein the plurality of slots are staggered from each other.

17. The magnetic assembly of claim 11, wherein one or more of the plurality of slots are oval shaped.

18. The magnetic assembly of claim 11, wherein one or more of the plurality of slots have ends that are wider than a center portion.

19. A method to restrain a component of a downhole tool, comprising:
positioning a first shoulder of a compressible sleeve against a component of the downhole tool, wherein the compressible sleeve and the component fit within an internal diameter of a collar of the downhole tool, the compressible sleeve comprising a plurality of slots extending along a curved surface of the compressible sleeve;
inserting a rotary connection of the downhole tool into the collar;
applying a threshold amount of preload force onto a second shoulder of the compressible sleeve to restrict movement of the component.

20. The method of claim 19 further comprising inducing a deflection of the compressible sleeve to control force applied to the component and to prevent overloading on the component.
